(19) United States
(12) Patent Application Publication
(10) Pub. No.: US 2008/0184044 A1
(43) Pub. Date: Jul. 31, 2008

(54) Method of managing power consumption for collections of computer systems

(76) Inventors: Phillip A. Leech, Houston, TX (US); Khaldoun Alzien, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/700,610

(22) Filed: Jan. 31, 2007

(51) Int. Cl. G06F 1/26

(52) U.S. Cl. 713/300; 713/321

(57) ABSTRACT

Embodiments include methods, apparatus, and systems for managing power consumption in a computer system. One embodiment includes a method that queries a blade for its power requirements when the blade is inserted into a blade computer enclosure. The method then determines, by the blade computer enclosure, whether the power requirements of the blade are within a power budget of the blade computer enclosure.

### CROSS-REFERENCES

This application is related to U.S. patent application Ser. Nos. 11/232,526 and 11/232525 both filed on Sep. 22, 2005, the disclosures of which are hereby incorporated by reference in their entirety.

### BACKGROUND

Blade computing represents a new, fast growing segment in the computing industry because of the compaction, consolidation, modularity, management and maintenance such computers. The growth in the use of blade computers has, however, led to ever increasing challenges in efficiently powering and cooling the blade computers. The challenges include attempts at minimizing the relatively high operational capital and recurring costs associated with enterprise environments having a relatively large number of blades. The challenges also include attempts at extending the useful lives of the blade computers by maintaining their temperatures and regulating their power consumptions within prescribed limits.

Heretofore, the power consumption of blade computers has not been efficiently managed to maintain performance and reduce power consumption. Instead, blade computers are often grouped together and over-provisioned in order to meet peak power demands. In these configurations, the blades inefficiently consume more power than is actually needed to perform the computing operations. Operation of computers at the over-provisioned levels has required that cooling resources also be increased to meet the higher demands which, in turn, further increases the inefficiencies associated with computer system operations.

### BRIEF DESCRIPTION OF THE DRAWINGS

FIG. 1A is a frontal view of a computer system in accordance with an exemplary embodiment of the present invention.

FIG. 1B is a frontal view of a computer system in accordance with an exemplary embodiment of the present invention.

FIG. 2 is a block diagram of a blade system in accordance with an exemplary embodiment of the present invention.

FIG. 3 is a block diagram of a power management system in accordance with an exemplary embodiment of the present invention.

FIG. 4 is a flow diagram of an algorithm for a power management agent in accordance with an exemplary embodiment of the present invention.

FIG. 5 is a graph of a power consumption for a hypothetical blade in accordance with an exemplary embodiment of the present invention.

FIG. 6 is a flow diagram of an algorithm for invalid power configuration decision in accordance with an exemplary embodiment of the present invention.

FIG. 7 is a block diagram of a blade power utilization measurement and reporting system in accordance with an exemplary embodiment of the present invention.

FIG. 8 is a block diagram of a circuit for determining an optimal current measurement location in accordance with an exemplary embodiment of the present invention.

FIG. 9 is a block diagram of a circuit for determining an optimal voltage measurement location in accordance with an exemplary embodiment of the present invention.

FIG. 10 is a block diagram of a measurement and reporting path in accordance with an exemplary embodiment of the present invention.

### DETAILED DESCRIPTION

Embodiments in accordance with the present invention are directed to apparatus, systems, and methods for managing power consumption in a computer system. One exemplary embodiment manages power for a set of computing devices (such as blades) within a group or enclosure. Each computing device reports its specific power requirements (determined at design time or through self measurement) to a responsible management agent. The agent in turn ensures that the addition of one or more computing devices to the group does not exceed a power budget for the entire group.

In one exemplary embodiment, a power management agent manages plural blades having blades with different power requirements and ensures quality power for each blade. For example, individual blades within a group may not be homogeneous and thus have different power requirements. By automatically calculating the overall power required using power related information from each blade and support subsystem, exemplary embodiments ensure that the power budget for the enclosure is not exceeded (thus solving potential power supply failures due to overloading).

One exemplary embodiment also provides a mechanism to dynamically measure in real-time the power utilization of a computing device and report this utilization to the enclosure power management agent. Exemplary embodiments enable applications such as power balancing and utility computing (i.e. user charged per kilowatts per hour of usage) to become realizable for blade computing.

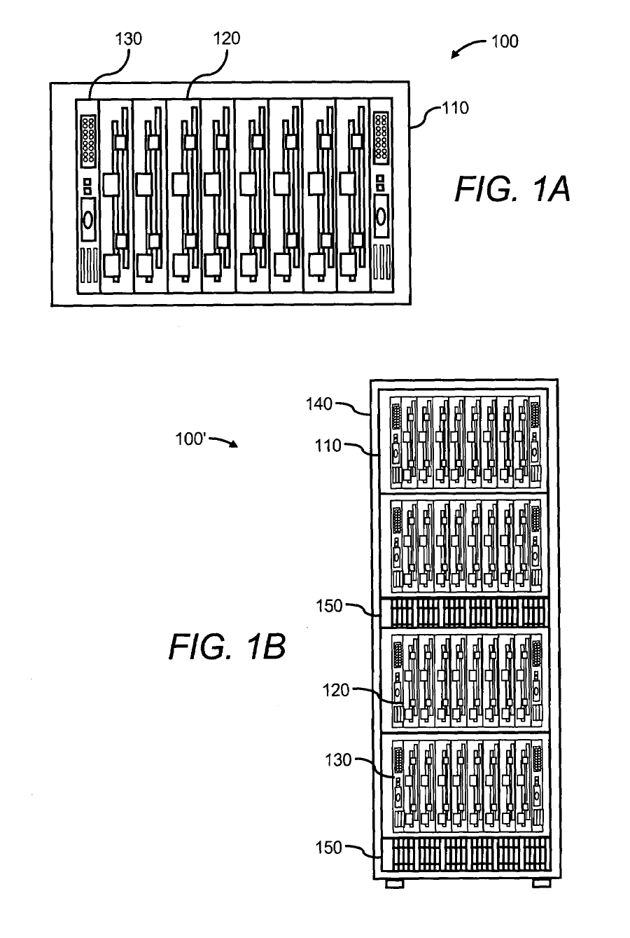

FIG. 1A shows a computer system 100 in accordance with an exemplary embodiment of the present invention. The system 100 includes an enclosure 110 housing a number of compute nodes 120, such as computer systems, servers, memories, hard drives, etc. In FIG. 1A, the compute nodes 120 are depicted as comprising blade servers or blade computers arranged in horizontal alignment with respect to each other in the enclosure 110. The compute nodes 120 are also depicted as including various components to form part of conventional electronic systems, such as various connectors, buttons, indicators, etc.

In addition to the compute nodes 120, the enclosure 110 includes other components, such as interconnects 130. The interconnects 130 generally operate to route network signals from the compute nodes 120. Two interconnects 130 are provided to provide redundancy for the compute nodes 120.

Although eight compute nodes 120 and two interconnects 130 are illustrated as being contained in the enclosure 110, any reasonably suitable number of compute nodes 120 and interconnects 130 can be included in the enclosure without departing from a scope of the invention. In addition, the electronic environment 100 can include additional components, and some of the components depicted can be removed and/or modified without departing from a scope of the electronic environment 100.

It should also be understood that various embodiments of the invention are practiced in computer systems, storage systems, and other electronic environments having different configurations than the system 100 depicted in FIG. 1A. By way of example, various embodiments of the invention are practiced in electronic environments having different types of compute nodes 120, for instance, in electronic environments having horizontally arranged servers. In addition, or alternatively, various embodiments of the invention are practiced in a larger scale computing environment in comparison with the electronic environment 100 depicted in FIG. 1A.

An example of a larger scale electronic environment 100′ is depicted in FIG. 1B. More particularly, FIG. 1B illustrates a simplified frontal view of a rack 140, such as an electronics cabinet housing four enclosures 110. The rack 140 is also depicted as including two sets of power supplies 150. The rack 140 can, however, house any reasonably suitable number of enclosures 110, such as, six, eight, or more, as well as any reasonably suitable number of power supplies 150. In addition, the enclosures 110 included in the rack 140 can also house any reasonably suitable number of compute nodes 120.

Various embodiments of the invention are further practiced in systems and electronic environments containing a relatively larger number of compute nodes 120 than are depicted in FIG. 1B. For instance, various embodiments of the invention are practiced amongst compute nodes contained in a data center or compute nodes positioned at different geographic locations with respect to each other. The different geographic locations include, for instance, different rooms, different buildings, different counties, different countries, etc.

One exemplary embodiment electronically determines and checks for validity of the power management configuration of the enclosure upon initial insertion and/or power-up of a blade or set of blades within the blade enclosure. Embodiments also enable dynamic power measurement of the power consumption of a blade or blades while the system operates.

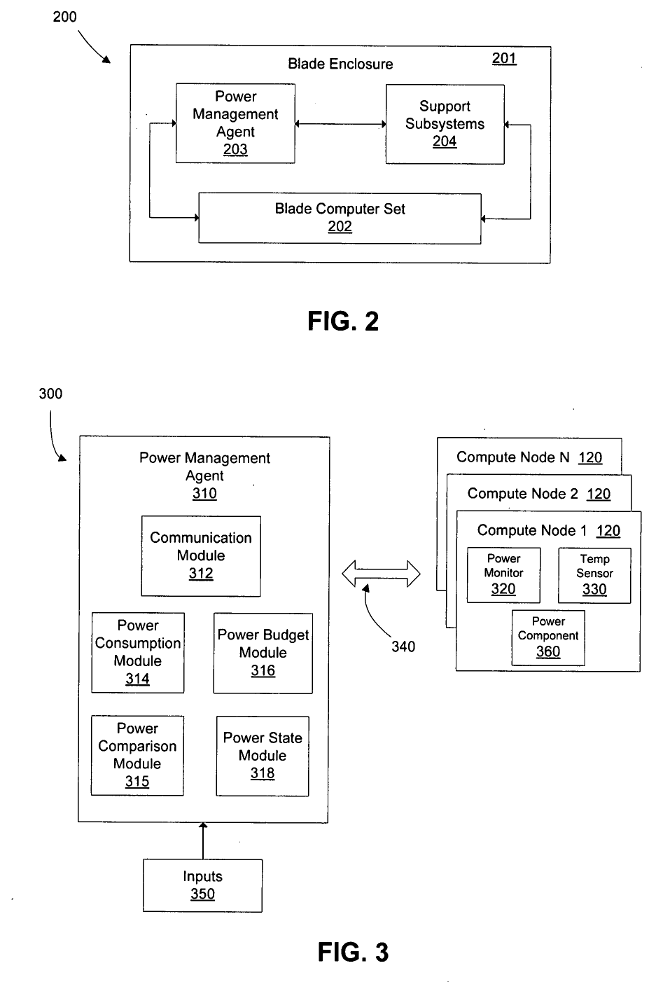

One exemplary embodiment includes two main components: 1) a measurement and reporting subsystem for power consumption of the blade computer and 2) an enclosure power management agent. FIG. 2 is a block diagram of a blade system 200 in accordance with an exemplary embodiment of the present invention. This figure shows a high level block diagram depicting the interaction of these two components within the context of an exemplary embodiment (such as shown in FIGS. 1A and 1B).

A blade enclosure 201 includes a set of blade computers 202, a power management agent 203, and support subsystems 204. All of these components are interconnected via electrical signals, buses, etc. that provide communication between these blocks. Preferably, the interconnect provides a reliable connectivity as a reasonably fast rate of transfer (example, at least one message per millisecond). Generally, this is required to be faster than the maximum rate of change of power consumption of the compute node with respect to time (preferably by one order of magnitude) which can be determined at design time.

FIG. 3 is a block diagram of a power management system 300 in accordance with an exemplary embodiment of the present invention. It should be understood that the following description of the power management system 300 is but one manner of a variety of different manners in which such a power management system 300 is operated. In addition, it should be understood that the power management system 300 can include additional components and that some of the components described can be removed and/or modified without departing from a scope of the power management system 300.

The following description of the power management system 300 makes specific reference to the elements depicted in the electronic environments 100, 100′. It should, however, be understood that the power management system 300 can be implemented in environments that differ from those environments 100, 100′ depicted in FIGS. 1A and 1B, as described above.

As shown in FIG. 3, the power management system 300 includes a power management agent 310. The power management agent 310 is depicted as including a communication module 312, a power consumption module 314, a power comparison module 315, a power budget module 316, and a power state module 318, which the power management agent 310 implements in performing various functions as described below. Some or all of the modules 312-318 comprise software stored either locally or in an external memory which the power management agent 310 implements. In addition, or alternatively, some or all of the modules 312-318 comprise one or more hardware devices that are implemented by the power management agent 310. As such, for example, the power management agent 310 is stored at a single location or the power management agent 310 is stored in a distributed manner across multiple locations, where the locations comprise at least one of hardware and software.

In one exemplary embodiment, the power management agent 310 is configured to enforce various conditions among the compute nodes 120, one of which is a power budget. The power management agent 310 comprises, for instance, a centralized module in an enclosure manager (not shown) of an enclosure 110 or a distributed control agent on one or more of the individual compute nodes 120. In addition, or alternatively, the power management agent 310 comprises a control agent stored in one or more compute nodes outside of an enclosure 110.

In one exemplary embodiment, the communication module 312 is configured to enable communications between the power management agent 310 and a plurality of compute nodes 120. The communication module 312 comprises software and/or hardware configured to act as an interface between the power management agent 310 and at least one other power management agent. The at least one other power management agent is located, for instance, in relatively close proximity to the power management agent 310, in a different geographic location as compared to the power management agent 310, etc. Communications between the power management agent 310 and the at least one other power management agent includes communications of power thresholds, policy recommendations, etc. In this regard, for instance, operations of the power management agent 310 described in greater detail herein below are performed by one or more power management agents 310.

The communication module 312 also comprises software and/or hardware configured to act as an interface between the power management agent 310 and the plurality of compute nodes 120 to thereby enable the communications. In one example, the power management agent 310 is configured to receive information pertaining to the amount of power being consumed by each of the compute nodes 120. The amount of power being consumed by each of the compute nodes 120 is detected through use of power monitors 320 associated with each of the compute nodes 120. The power monitors 320 comprise, for instance, relatively simple current sense resistors connected to an analog-to-digital converter. In addition, or alternatively, the power monitors 320 comprise software configured to calculate the amounts of power consumed by the compute nodes 120.

The power management agent 310 also receives information pertaining to the temperatures of the compute nodes 120. The temperatures of the compute nodes 120 are detected by one or more temperature sensors 330, which include, for instance, thermometers, thermistors, thermocouples, or the like.

Information pertaining to the amount of power being consumed by the compute nodes 120 and the temperatures of the compute nodes 120 are transmitted to the power management agent 310 as indicated by the arrow 340. In this regard, the arrow 340 represents, for instance, a network, a bus, or other communication means configured to enable communications between the power management agent 310 and the compute nodes 120. In addition, the arrow 340 represents communication means between the power management agent 310 and compute nodes 120 housed in one or more enclosures 110, one or more racks 140, one or more data centers, etc. As such, for instance, the power management agent 310 enforces a power budget across multiple compute nodes 120, regardless of their geographic locations with respect to each other and the power management agent 310.

The power management agent 310 implements the power consumption module 314 to monitor the current power consumption levels of the compute nodes 120. The power management agent 310 also implements the power consumption module 314 to compare the current power consumption levels with a power budget. In addition to the current power consumption levels, the power management agent 310 also implements the power comparison module 315 to compare pending increases in the power utilization levels of the compute nodes with the power budget.

The power management agent 310 also receives inputs 350 from one or more sources. For instance, the power management agent 310 receives the terms of a service level agreement (“SLA”) and power budget levels from an administrator or from a program configured to supply the power management agent 310 with the SLA terms and power budget levels. The power management agent 310 also receives information pertaining to current or pending utilization levels of the compute node 120 power components 360. The power components 360 comprises, for instance, processors, memories, disk drives, or other device in the compute nodes 120 whose power state is detected and varied. In addition, the power components 360 have a plurality of power states. For instance, the power components 360 have a minimum power state, such as, when the power components 360 are idle and a maximum power state, such as, when the power components 360 are fully operational. In addition, for instance, the power components 360 have one or more power states between the minimum power state and the maximum power state, at which the power components 360 are operated.

The power management agent 310 implements the power budget module 316 to determine the power budget and the power budget threshold enforced by the power management agent 310 at design time or at run-time. The power budget is determined at design time based upon various constraints of the electronic environment 100, 100′ if, for instance, the targeted benefits of the power budget enforcement are geared towards reducing the provisioning of cooling and power delivery or increasing flexibility in the choice of components selected for the electronic environment 100, 100′. For example, reverse calculations from a specific cooling or power delivery budget are implemented to determine the selected power budget value and associated power budget threshold.

The power management agent 310 receives the current or pending power component 360 utilization levels from, for instance, a workload managing module (not shown) configured to direct workloads to the compute nodes 120. In addition, or alternatively, current or pending utilization levels are directly transmitted to the compute nodes 120 and the compute nodes 120 communicate the current or pending utilization levels to the power management agent 310.

The power management agent 310 implements the power state module 318 to determine the power states for the compute nodes 120, such that the compute nodes 120 are operated in manners that reduce the power consumption levels of the compute nodes 120 while substantially ensuring that other system requirements are not unduly compromised. The other system requirements include, for instance, reliability requirements, such as, adherence to a pre-specified power budget, performance requirements, or other quality-of-service metrics specified by an application, such as the requirements set forth in an SLA.

The power management agent 310 determines whether the sum of the current power consumption levels of the compute nodes 120 in the compute node pool and the requested power increase in the compute node 120 falls below an allowable power budget for the compute node pool, as indicated at step 412. The allowable power budget and an associated allowable power budget limit for the compute node pool are determined at design time or they comprise run-time configurable system parameters. The allowable power budget and associated limit are determined at design time based upon various constraints of the electronic environment 100, 100′ if, for instance, the targeted benefits of the power budget enforcement are geared towards reducing the provisioning of cooling and power delivery or increasing flexibility in the choice of components selected for the electronic environment 100, 100′. For example, reverse calculations from a specific cooling or power delivery budget are implemented to determine the allowable power budget.

In other instances, the allowable power budget and associated limit of the compute node pool may comprise a run-time parameter that is varied based on an external trigger, such as, power supply failure, reduced resource utilizations, etc. In addition, the specific value and the level of rigidity in the enforcement of the power budget may depend upon the objective function being optimized and the level of aggressiveness in the design of components included in the electronic environment 100, 100′. For example, the system power budget may be set to a power budget value close to the estimated 90^{th} percentile of typical usage of the expected workloads, determined, for instance, through profiling, with an “allowance factor” for unexpected transients. In this example, more conservative power budget value settings may use an estimate of the peak values while more aggressive approaches may use the estimated average power consumption values. Similarly, optimizations targeting cooling and average power may be more relaxed about brief transients when the power budget is not enforced versus optimizations targeting power delivery.

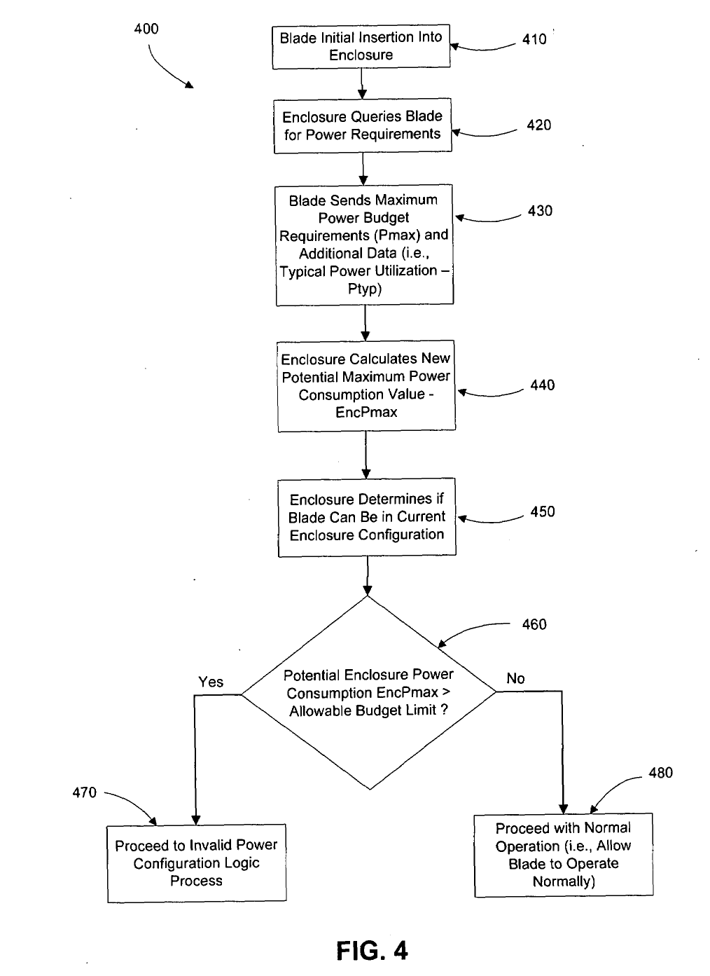

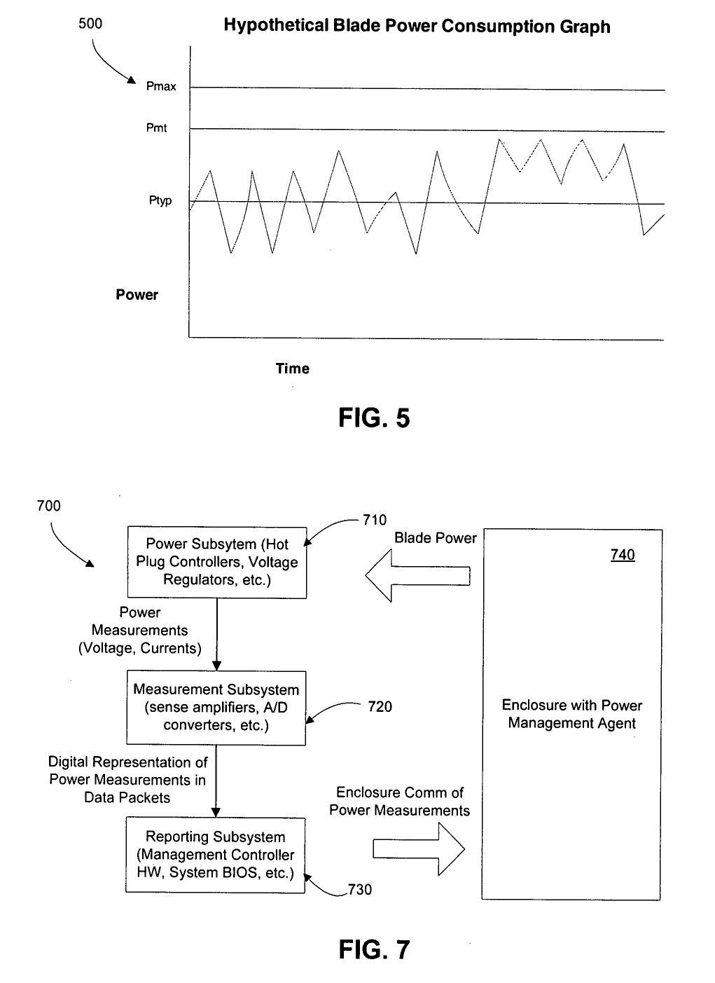

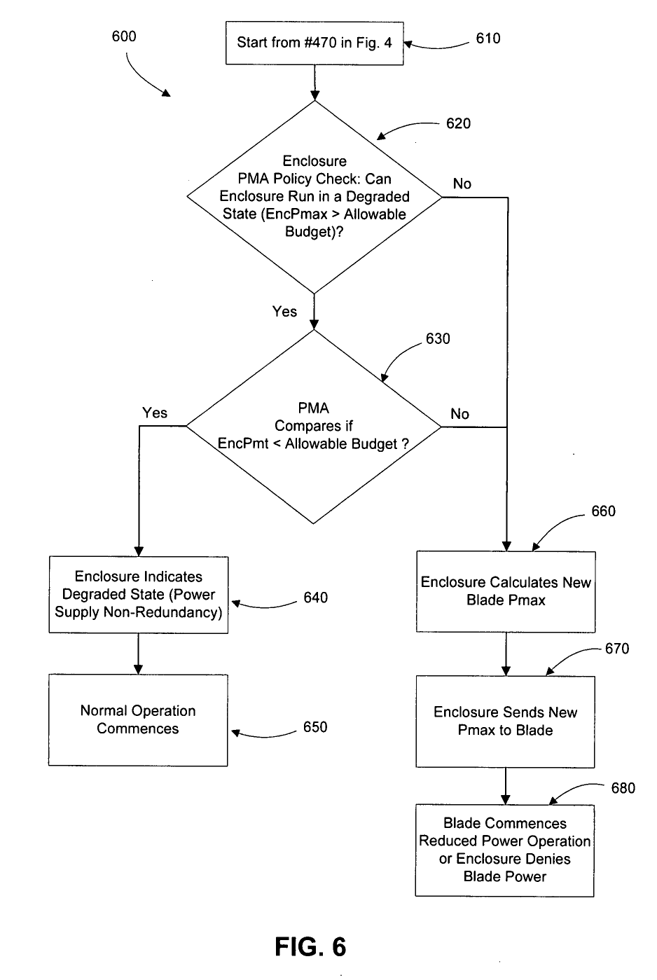

FIG. 4 is a flow diagram of an algorithm 400 for a power management agent in accordance with an exemplary embodiment of the present invention. The power management agent implements the determination of power configurations dynamically during run time usage of the enclosure or blade set.

According to block 410, the beginning state starts the process with the blade being initially inserted into the blade enclosure.

According to block 420, insertion of the blade causes the enclosure to query the blade for its power requirements. Alternatively, the power management agent automatically obtains the power requirements.

According to block 430, the blade transmits its power requirements to the enclosure. This data includes such numbers as maximum power consumption, Pmax, calculated using databook maximum values at design time, typical power consumption, Ptyp, and/or a hybrid value between the two Pmt which would represent the maximum possible power consumption under the normal specified operating conditions (measured at design time or self measured).

For illustrative purpose, FIG. 5 shows a hypothetical example graph 500 containing a power utilization chart of a typical blade and the aforementioned levels. By way of example, all of these values are determined at design time or measured using the measurement mechanisms described herein. Similarly, an enclosure can have equivalent power thresholds EncPmax, EncPmt, and EncPtyp that represent the sum of all power consuming subsystems within the enclosure.

According to block 440, the enclosure power management agent re-calculates the new current maximum potential power consumption, EncPmax, for the entire enclosure using the data provided by the newly inserted blade. In one exemplary embodiment, a determination of EncPtyp and EncPmt are calculated and used as well by the enclosure's power management agent.

According to block 450, the enclosure then determines if the blade can be normally operated in the current power configuration of the enclosure. This proceeds to the decision point in state according to block 460.

According to block 460, the question is asked whether the potential enclosure power consumption, EncPmax, would exceed the allowable budget limit. If the answer to this question is “yes” then flow proceeds to block 470. If the answer to this question is “no” then flow proceeds to block 480.

Block 460 represents the decision point at which the enclosure compares the newly calculated enclosure power consumption with the allowable budget limit. This budget limit, EncPlimit, could have been defined at run time by the customer to meet customer specific data center cooling needs or determined at design time based on such parameters as power supply limitations (maximum current or wattage) or other parameters as cooling capability of the enclosure chassis. The comparison of Enclosure Power Consumption to EncPlimit proceeds to either one of two states (i.e., blocks 470 or 480).

According to block 470, if the newly calculated enclosure power consumption is greater than the allowable budget limit, then the management agent proceeds to an invalid power configuration logic process. In this state, the power management agent indicates whether the enclosure is in an invalid power configuration. This may result in informing via the enclosure's various user interfaces (command line or graphical) or this condition. It may also, depending on policy settings by the administrator or customer, disallow normal operation of the newly inserted blade until corrective action occurs.

According to block 480, this state indicates that the power management agent determined that the newly calculated power consumption is within the allowable limits for the enclosure.

FIG. 6 is a flow diagram of an algorithm 600 for invalid power configuration decision in accordance with an exemplary embodiment of the present invention. Upon detecting an invalid power configuration, multiple outcomes can result depending on policy settings set at design time or configured by the customer.

According to block 610, the state is entered from number 470 in FIG. 4. The power management agent checks policy settings and does so in block 620.

According to block 620, the enclosure power management agent (PMA) performs a check: Can the enclosure run in a degraded state wherein EncPmax>the allowable budget? If the answer to this question is “yes” then flow proceeds to block 630. If the answer to this question is “no” then flow proceeds to block 660.

The power management agent checks or determines if the enclosure can run in a potentially degraded state. For example, this determination could mean the customer has set the policy for allowing a non-redundant power configuration to exist. For instance, a given enclosure could have two power supplies running up to 50% capacity maximum such that if one fails the other can provide the full 100% capacity in that event. If the customer is willing to forego this feature then one or more supplies could provide capacity above the 50% limit.

According to block 630, a determination is made by the power management agent (PMA) as to whether the EncPmt<the allowable budget. If the answer to this determination is “yes” then flow proceeds to block 640. If the answer to this determination is “no” then flow proceeds to block 660.

In block 630, a further check could be introduced depending on whether additional power related parameters from the blades and subsystems are used. For instance, if Pmt is used then the agent could compare EncPmt to the maximum allowable budget. Thus to add an additional level of logic to check how extreme the current enclosure utilization is over the allowable limit can be implemented and used by the agent. This implementation can also depend on policy, but for one exemplary embodiment it is shown as further checks and decisions could be implemented (such as one for Ptyp and EncPtyp).

According to block 640, the enclosure indicates a degraded state. Here, the agent signals the degraded state and also signals which condition (power supply non-redundancy) the enclosure is in. Also, the allowable limit indicates a thermal cooling limitation of the enclosure as well and sets up on a policy basis (i.e. one level for cooling, another for power supply redundancy). According to block 650, normal operations then commence.

According to block 660, the enclosure calculates a new blade Pmax for the newly inserted blade. In one exemplary embodiment, the blade measures its own power consumption. Also, the blade can use the measured power consumption values to enforce subsystem consumptions policies and thus ensure consumption stays under the new Pmax value that the enclosure provided.

According to block 670, the enclosure sends the new Pmax value to the blade. The blade adjusts its consumption. Then, according to block 680, upon reception of the new value, Pmax, the blade commences operation within a reduced power envelope. If the blade cannot operate within the adjusted power envelope, then the enclosure can deny power by forcing the blade to power off.

Power is measured and reported by the blade computer to the enclosure power management agent using various methods. FIG. 7 is a block diagram of a blade power utilization measurement and reporting system 700 in accordance with an exemplary embodiment of the present invention.

The system includes a blade computers power subsystem 710 that gets power from the enclosure's power subsystem. The measurement subsystem 720 has hooks into the power subsystem 730 for measuring voltage and current parameters of interest such that subsystem 720 can determine the blade's power consumption. Then, this information is transferred to the reporting subsystem 730 which then prepares for transfer to the enclosure 740 for its power management agent to use. This transfer can be done dynamically and periodically during the course of normal operation of the blade with the management agent providing periodic updates in power consumption and thus dynamically checking for valid power configuration.

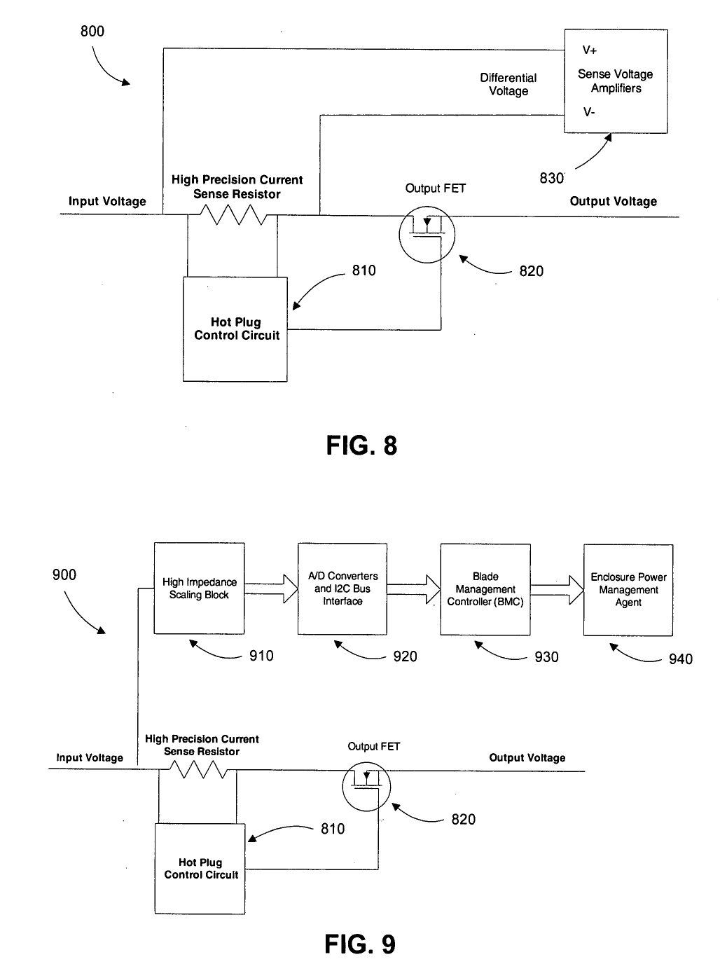

FIG. 8 is a block diagram of a circuit 800 for determining an optimal current measurement location in accordance with an exemplary embodiment of the present invention. Generally, the circuit includes a hot plug control circuit 810 coupled to an output FET (field effect transistor) 820 and sense voltage amplifiers 830.

FIG. 9 is a block diagram of a circuit 900 for determining an optimal voltage measurement location in accordance with an exemplary embodiment of the present invention. The hot plug control circuit is coupled to the FET as in FIG. 8. A high impedance scaling block 910 provides output to A/D (analog to digital) converters and 12C bus interface (inter-integrated circuit). Output then flows to an embedded microcontroller which collects and pre-processes the data for use by the enclosure power management agent.

In one exemplary embodiment, measurement at the hot plug controllers is optimal since the measuring devices require current sense resistors in the current path which is what the hot plug controllers already use. FIGS. 8 and 9 indicate where the optimal power parameter (current and voltage) measurements need to be located for the preferred embodiment. FIG. 8 shows the measurement and reporting data path for one exemplary embodiment. Additional embodiments are implemented using different measurement devices and bus interfaces. Additionally, the reporting mechanism does not have to be implemented with a management controller but possible via the SMI mechanism provided by the blade host processor and the blade system BIOS (basic input/output system).

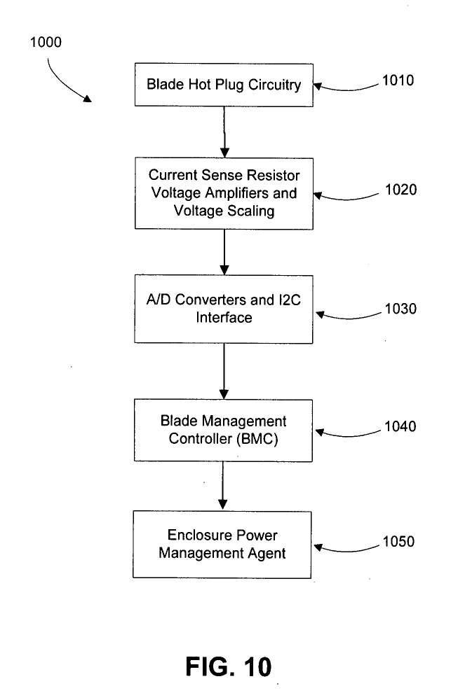

FIG. 10 is a block diagram of a measurement and reporting path 1000 in accordance with an exemplary embodiment of the present invention. Generally, output flows as follows: Blade hot plug circuitry 1010 provides output to current sense resistor voltage amplifiers and voltage scaling 1020. Output is then directed to A/D converters and 12C interface 1030. Output from this block then proceeds to the blade management controller 1040 and to the enclosure power management agent 1050.

Exemplary embodiments implement a mechanism to measure and report, real-time, the instantaneous power utilization of a blade computing device. Embodiments measure and report the actual physical utilization of power of blades. Further, one embodiment electronically determines power requirements rather and does not depend on design time spreadsheet or configuration utility calculations. Thus, this embodiment eliminates power subsystem failures due to overloading cause by configuration error. Additionally, exemplary embodiments enable more advanced applications, such as power balancing or utility computing (i.e. user charged per kilowatt-hour of usage), to be realized by blade computing devices.

In one exemplary embodiment, one or more blocks or steps discussed herein are automated. In other words, apparatus, systems, and methods occur automatically. As used herein, the terms “automated” or “automatically” (and like variations thereof) mean controlled operation of an apparatus, system, and/or process using computers and/or mechanical/electrical devices without the necessity of human intervention, observation, effort and/or decision.

As used herein, a “blade” is a standardized electronic computing module that is plugged in or connected to a computer or storage system. A blade enclosure provides various services, such as power, cooling, networking, various interconnects and management service, etc for blades within the enclosure. Together the individual blades form the blade system. The enclosure (or chassis) performs many of the non-core computing services found in most computers. Further, many services are provided by the enclosure and shared with the individual blades to make the system more efficient. The specifics of which services are provided and how vary by vendor.

The methods in accordance with exemplary embodiments of the present invention are provided as examples and should not be construed to limit other embodiments within the scope of the invention. For instance, blocks in diagrams or numbers (such as (1), (2), etc.) should not be construed as steps that must proceed in a particular order. Additional blocks/steps can be added, some blocks/steps removed, or the order of the blocks/steps altered and still be within the scope of the invention. Further, methods or steps discussed within different figures can be added to or exchanged with methods of steps in other figures. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments and steps associated therewith are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A method, comprising:
querying a blade for its power requirements when the blade is inserted into a blade computer enclosure; and
determining, by the blade computer enclosure, whether the power requirements of the blade are within a power budget of the blade computer enclosure.

2) The method of claim 1 further comprising, allowing the blade to operate in the blade computer enclosure when the power requirements of the blade do not exceed the power budget.

3) The method of claim 1 further comprising, prohibiting the blade from operating in the blade computer enclosure when the power requirements of the blade exceed the power budget.

4) The method of claim 1 further comprising, calculating a maximum potential power consumption for the blade computer enclosure using data in the power requirements of the blade.

5) The method of claim 1 further comprising, sending a value for maximum power consumption from the blade to the blade computer enclosure as part of the power requirements.

6) The method of claim 1 further comprising, sending an average power consumption value from the blade to the blade computer enclosure as part of the power requirements.

7) The method of claim 1 further comprising:
calculating a potential power consumption value of the blade enclosure if the blade is added to the blade enclosure;
comparing the potential power consumption value to a power budget value to determine if the blade is allowed to operate in the blade enclosure.

8) A computer readable medium having instructions for causing a computer to execute a method, comprising:
receiving power requirements from a blade before operating the blade in an enclosure housing plural blades; and
calculating whether the power requirements of the blade are within a power budget of the enclosure.

9) The computer readable medium of claim 8 further comprising:
calculating a power consumption value for the plural blades including the power requirements of the blade;
comparing the power consumption value with a power budget limit for the enclosure.

10) The computer readable medium of claim 8 further comprising, providing an indication that the enclosure is operating in an invalid power configuration if the power requirements of the blade cause power requirements of the enclosure to exceed a predetermined value.

11) The computer readable medium of claim 8 further comprising, determining if the enclosure can run in a degraded state if the blade is allowed to operate in the enclosure.

12) The computer readable medium of claim 8 further comprising:
requesting that the blade operate in the enclosure with a reduced power envelope;
forcing the blade to power off if the blade does not operate in the reduced power envelope.

13) The computer readable medium of claim 8 further comprising:
operating the enclosure in a redundant power configuration;
eliminating the redundant power configuration in order to enable the blade to operate within power limits of the enclosure.

14) The computer readable medium of claim 8 further comprising:
allowing the blade to operate in the enclosure;
periodically measuring and reporting power consumption of the blade to the enclosure.

15) The computer readable medium of claim 8 further comprising:
calculating a power consumption of the enclosure while the plural blades are operating;
comparing the power consumption of the enclosure with power values to determine if the enclosure is operating in an acceptable power range.

16) A computer system, comprising:
plural blade computers; and
an agent that (1) receives power requirements from a blade before the blade is authorized to operate in the computer system and (2) computes potential power usages of the plural blade computers plus the blade to determine if the blade is authorized to operate in the computer system.

17) The computer system of claim 16, further comprising a power subsystem, and a measurement subsystem having hooks in the power subsystem for measuring voltage and current parameters so the agent can determine power consumption of the blade.

18) The computer system of claim 16, wherein the agent further (3) periodically calculates updates to power usages after the blade is authorized to operate in the computer system.

19) The computer system of claim 16, wherein the agent further (3) electronically determines power requirements for the computer system in order to eliminate power system failures due to overloading.

20) The computer system of claim 16, wherein the agent further (3) allows the blade to operate in the computer system when the power requirements of the blade do not exceed a power budget.
